(19) United States
(12) Patent Application Publication
(10) Pub. No.: US 2013/0213481 A1
(43) Pub. Date: Aug. 22, 2013

(54) SELF-STARTING SUPERSONIC INLET

(71) Applicant: GOHYPERSONIC, INC., (US)

(72) Inventors: Travis W. Drayna, Shoreview, MN (US); Lance S. Jacobsen, Washington Township, OH (US); Andrew C. Dwenger, Dayton, OH (US)

(73) Assignee: GOHYPERSONIC, INC., Dayton, OH (US)

(21) Appl. No.: 13/645,684

(22) Filed: Oct. 5, 2012

Related U.S. Application Data
(60) Provisional application No. 61/553,892, filed on Oct. 31, 2011.
(60) Provisional application No. 61/543,805, filed on Oct. 5, 2011.

(51) Int. Cl. F02K 7/14; G06F 17/50

(52) U.S. Cl. CPC F02K 7/14; G06F 17/5095
USPC 137/1; 137/15.1; 703/8

(57) ABSTRACT

A dual-compression stage inlet for supersonic applications is developed by defining a first inlet model, defining a second inlet model and blending, with a processor, the first inlet model and the second inlet model to derive a third inlet model, which models the desired dual-compression stage inlet.

### CROSS REFERENCE TO RELATED APPLICATIONS

This application claims the benefit of U.S. Provisional Patent Application Ser. No. 61/543,805 filed Oct. 5, 2011, the disclosure of which is hereby incorporated by reference in its entirety. Further, this application also claims the benefit of U.S. Provisional Patent Application Ser. No. 61/553,892 filed Oct. 31, 2011, the disclosure of which is hereby incorporated by reference in its entirety.

### STATEMENT REGARDING FEDERALLY SPONSORED RESEARCH OR DEVELOPMENT

This invention was made with government support under Contracts No. FA8650-08-M-2818 and No. FA8650-10-M-2018 awarded by U.S. Air Force. The Government has certain rights in this invention.

### BACKGROUND

The present invention relates to inlets for supersonic applications and specifically to self-starting inlets for supersonic applications.

A scramjet is a variant on a ramjet air-breathing jet engine, which relies on high vehicle speed to forcefully compress and decelerate the incoming air before combustion. Particularly, the scramjet keeps the airflow at supersonic speeds throughout the entire engine and does not require the air to be completely decelerated below supersonic speeds for combustion.

### BRIEF SUMMARY

According to various aspects of the present invention, a method is disclosed for developing a dual-compression stage inlet for supersonic applications. The method comprises defining a first inlet model, defining a second inlet model and blending, with a processor, the first inlet model and the second inlet model to derive a third inlet model, which models the desired dual-compression stage inlet.

As an illustrative example, a user defines a first inlet model by defining a leading edge shape and propagating a streamline to derive a throat shape of the first inlet model. The user defines a second inlet model by defining a throat shape and propagating a streamline to derive a leading edge shape of the second inlet model. The user blends the first inlet model and the second inlet model to derive a third inlet model, which models the desired dual-compression stage inlet.

According to further aspects of the present invention, a method is disclosed for reducing internal shockwave strength in a supersonic inlet. Air is fed into a primary compression stage of an inlet. The primary compression stage includes an apex that is offset from a flowfield axis of the inlet to form an apex ring around the flowfield axis. The air is then directed into a secondary compression stage, which is inverted from the primary compression stage. Further, a throat of the secondary compression stage is offset from the primary compression stage.

According to still further aspects of the present invention, a dual-compression inlet for a supersonic application is disclosed. The dual-compression inlet includes a primary compression stage including a crotch and a curve. The primary compression stage feeds into a secondary compression stage, which has a curve that is inverted from the curve of the primary compression stage. Further, the secondary compression stage includes a throat that is offset from the primary compression stage.

### BRIEF DESCRIPTION OF THE SEVERAL VIEWS OF THE DRAWINGS

FIG. 1 is a diagram that illustrates an axisymmetric dual-compression flowfield, according to various aspects of the present invention;

FIG. 2 is a side view of a supersonic inlet based on the axisymmetric dual-compression flowfield of FIG. 1, according to various aspects of the present invention;

FIG. 3 is a flow chart illustrating a method to develop a dual-compression stage inlet for supersonic applications, according to various aspects of the present invention;

FIG. 4 is a flow chart illustrating a method to create a supersonic inlet based on the axisymmetric dual-compression flowfield of FIG. 1 and the method of FIG. 3, according to various aspects of the present invention;

FIG. 5 is a flow chart illustrating a method for reducing internal shockwave strength in a supersonic inlet, according to various aspects of the present invention; and

FIG. 6 is a block diagram of an exemplary computer that can perform the method of FIGS. 3-5 and other methods, according to various aspects of the present invention.

### DETAILED DESCRIPTION

According to various aspects of the present invention, a self-starting supersonic inlet is provided, as described below with reference to the accompanying drawings. In this manner, aspects of the present invention can be carried out in a variety of different modes and should not be limited to the content of the description of any particular embodiment. As used herein, “supersonic” is used generally to mean greater than the speed of sound, and thus includes hypersonic within its definition. As used herein, a “supersonic engine” is any engine that can be used at supersonic flight speeds.

A scramjet engine includes in general, an inlet, an isolator, and a combustor. The inlet provides a compression of air that can be initially compressed by a forebody of the vehicle. The isolator allows a supersonic airflow to compress to a static back-pressure higher than the inlet throat static pressure. The combustor accepts the airflow from the isolator and provides fuel-air mixing necessary for combustion and a desired engine thrust.

According to various aspects of the present invention, inlets are disclosed for supersonic applications, which prevent or mitigate inlet unstart. As such, the inlets described below are suitable in the operation of hypersonic air-breathing vehicles. Moreover, the inlets described below avoid the need for large mechanical inlet starting doors and avoid aggressive application of boundary layer bleed.

In this regard, various aspects of the present invention provide a self-starting inlet for supersonic applications, including hypersonic air-breathing flight vehicles. The self-starting inlet provides passive inlet starting at low supersonic Mach numbers, provides inlet operability over a wide range of flight conditions, and provides mitigation of backpressure-induced inlet unstart.

Inlet For Engine Self-Start

In general, supersonic inlets must have high contraction ratios to enable the engine to produce high combustion efficiency and good overall engine performance. However, inlets with high total contraction ratios typically have high internal contraction ratios as well. Based on quasi one-dimensional inviscid theory, two contraction ratio limits are defined for generic inlets.

The first limit, known as the isentropic limit, defines the maximum total contraction ratio that the flow can withstand at any given flight Mach number. The second contraction ratio limit, known as the Kantrowitz limit, defines the maximum internal contraction ratio that an inlet can have for passive inlet starting. Based on inviscid theory, inlets with an internal contraction ratio below the Kantrowitz limit will not require starting devices. Therefore, an inlet with an internal contraction ratio at or below the Kantrowitz limit can passively self-start a corresponding scramjet engine (e.g., as long as there are no strong viscous effects).

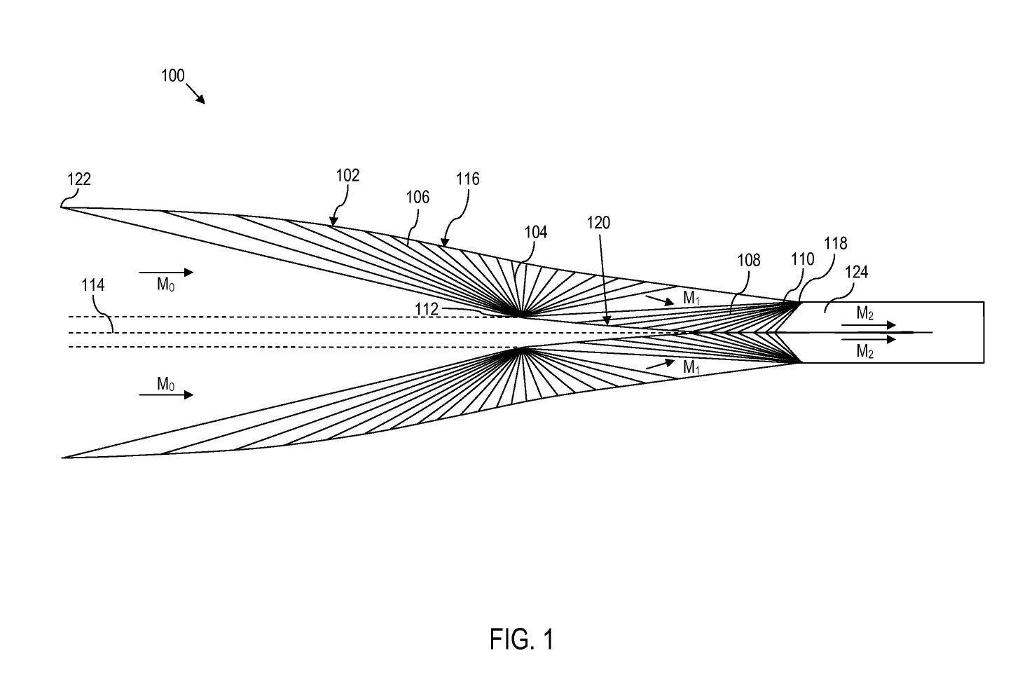

Turning now to the figures and in particular to FIG. 1, within an inlet, a dual-compression flowfield 100 with a desired streamline 102 is shown in an axisymmetric, annular form sliced through its diameter. A flow of air M₀, M₁, M₂ undergoes two isentropic compression regions: a primary compression region 104 (i.e., primary compression stage) defined by a primary compression fan 106 and a secondary compression region 108 (i.e., secondary compression stage) defined by a secondary compression fan 110. The primary compression fan 106 includes an apex 112 offset from a flowfield axis 114 and creates a curve 116 on the streamline 102. As used herein, element 112 is referred to as an apex when used in the context of discussing the primary compression fan 106. However, the element 112 is referred to as a crotch when used in the context of describing a feature of the inlet. In this illustration, the crotch of the inlet defines a location corresponding to the apex of the primary compression fan 106.

Similar to the primary compression fan 106, the secondary compression fan 110 includes an apex 118 and a curve 120. However, the curve 120 of the secondary compression fan 110 is inverted (i.e., curved in the opposite direction) from the curve 116 of the primary compression fan 106.

At the “design” condition of the inlet, as air M₀ (i.e., freestream) flows into the primary compression region 104, an oblique shockwave begins to emanate off of a leading edge 122 of the streamline 102. The shockwave turns and creates another shockwave off of the crotch 112 (i.e., at the apex of the primary compression fan 106). The air M₁ flows from the primary compression region 104 to the secondary compression region 108, which includes a gradual turning in the opposite direction from the curve 116 in the primary compression region 104. Thus, a throat 124 of the secondary compression region 108 is offset perpendicular to the freestream flow M₀ towards the flowfield axis 114 from the primary compression stage 104. This gradual turning and offset throat 124 keeps the shockwave generated at the crotch 112 highly oblique compared to the streamline 102. In practice, a shockwave may not be directly created. Rather, a Mach wave or characteristic wave may be created, which requires truncation of the inlet streamlines at the leading edge back to create a turning angle, which creates the shockwave. Also, at the crotch, the leading edge is blunt, so the shockwave begins as a bow shock off of the leading edge and curves into an oblique shockwave as it propagates away from the leading edge radius, downstream into the secondary compression flowfleld.

When the shockwaves are kept highly oblique to the streamline 102, a likelihood of shock-induced boundary layer separation within the secondary compression region 108 is mitigated. Mitigating this shock-induced separation also mitigates a likelihood of unstart within a scramjet and promotes inlet self-starting as long as the internal contraction ratio is below Kantrowitz criterion.

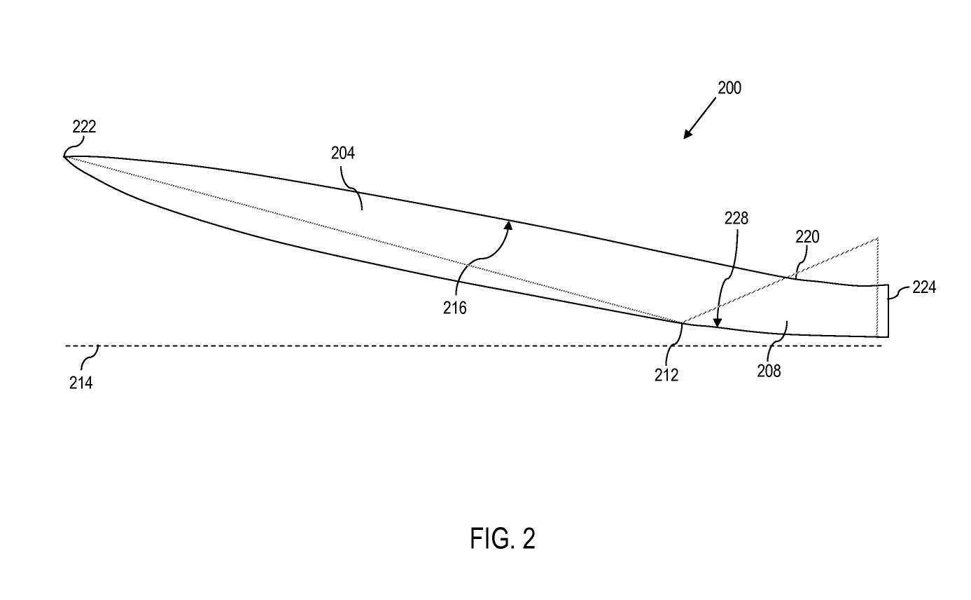

FIG. 2 illustrates the streamline 102 of FIG. 1 as a top portion of an exemplary inlet 200 for a scramjet. The inlet 200 includes a primary compression stage 204 and a secondary compression stage 208. The primary compression stage 204 is modeled off of the primary compression fan 106 in FIG. 1 and includes an apex 212 (i.e., crotch), which is offset from a flowfield axis 214. The primary compression stage 204 curves toward the flowfield axis 214 along an internal surface 216 (i.e., internal streamline).

The primary compression stage 204 feeds into the secondary compression stage 208 gradually matching up with a curvature 220 of the secondary compression stage 208, which curves in the reverse direction of the curve of the internal surface 216 of the primary compression stage 204. The secondary compression stage 208 includes a throat 224 that is offset from the primary compression stage 204 towards the flowfield axis 214 and feeds into the isolator (not shown) and combustor (not shown) of the scramjet engine. When air flows from the primary compression stage 204 into the secondary compression stage 208, the flow of air should align with the start of the internal surface 228 of the secondary compression stage 208 (i.e., the start of the internal surface 228 is at the crotch 212).

This alignment reduces shockwave compression strength of any shockwaves emanating from the crotch 212 into the secondary compression stage 208 of the inlet 200 and makes the shockwaves highly oblique as those shockwaves propagate downstream.

Thus, according to various aspects of the present invention, an inlet for supersonic applications (e.g. scramjet engines) comprises a primary compression stage that includes a crotch, and a curve. The inlet also comprises a secondary compression stage that includes a curve that is inverted from the curve of the primary compression stage, and a throat that is offset from the primary compression stage. The secondary compression stage can feed an isolator of the scramjet engine, for instance.

According to further aspects of the present invention, the crotch can couple with the secondary compression stage such that an internal surface at the crotch aligns with a flow of air from the crotch to the second compression stage. Additionally, the throat can be offset from the primary compression stage in the direction of a flowfield axis. Further, a primary apex can be offset from a flowfield axis of the inlet to the scramjet, forming an apex ring around the flowfield axis. As such, the secondary compression stage is sufficiently offset from the primary compression stage to weaken the strength of shockwaves that propagate in the inlet. Moreover, the secondary compression stage can thus include a maximum internal compression ratio equal to a Kantrowitz limit to allow the scramjet engine to self-start. The compression ratio can alternatively be slightly over the Kantrowitz limit, e.g., due to 3D flow and viscous affects.

According to still further aspects of the present invention, the curves at a boundary plane between a primary compression flowfield and a secondary compression flowfield are parallel to each other, providing a smooth and continuous transition.

According to still further aspects of the present invention, the inlet is free of variable geometry. In this regard, the inlet may be derived from two axisymmetric flowfields (e.g., where each axisymmetric flowfield is an annular flow).

According to further aspects of the present invention, the length of the inlet can be reduced over traditional inlets. This reduced length reduces viscous drag and reduces the overall length of the engine (i.e., for a given overall engine length, a shorter inlet can be used to accommodate a longer isolator). Further, reduced inlet length will place inlet forces and moments dimensionally closer to the vehicle center of gravity; thus, minimizing the detrimental effects on vehicle characteristics and trim.

The downward direction of the internal contraction section produces a much more gradual turning of the flow than seen in other inlet styles (e.g., Busemann style). The downward direction near the crotch reduces the strength of the bow shock emanating from the crotch and eventually reflecting off the body side of the inlet. This reduction in strength leads to stability of the boundary layer near the shock reflection, reducing the possibility of unstart.

Geometry-based shape transition techniques can be used to determine the transition of the inlet flowfields from the streamlines traced from the inlet lip shape to selected combustor shapes (e.g., round with a round cross section, planar with a rectangular cross section, etc.) within scramjet engines while preserving the fundamental flow features associated with the two compression stage method.

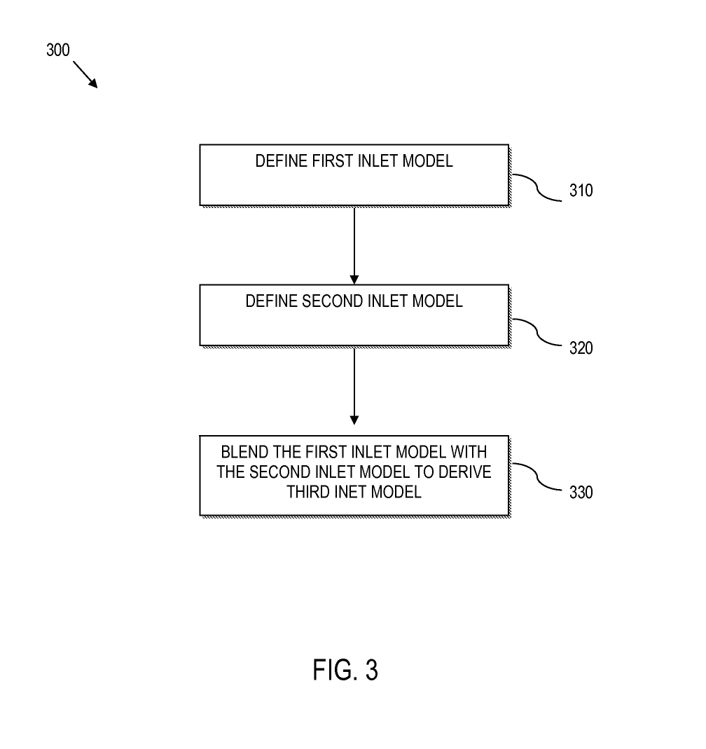

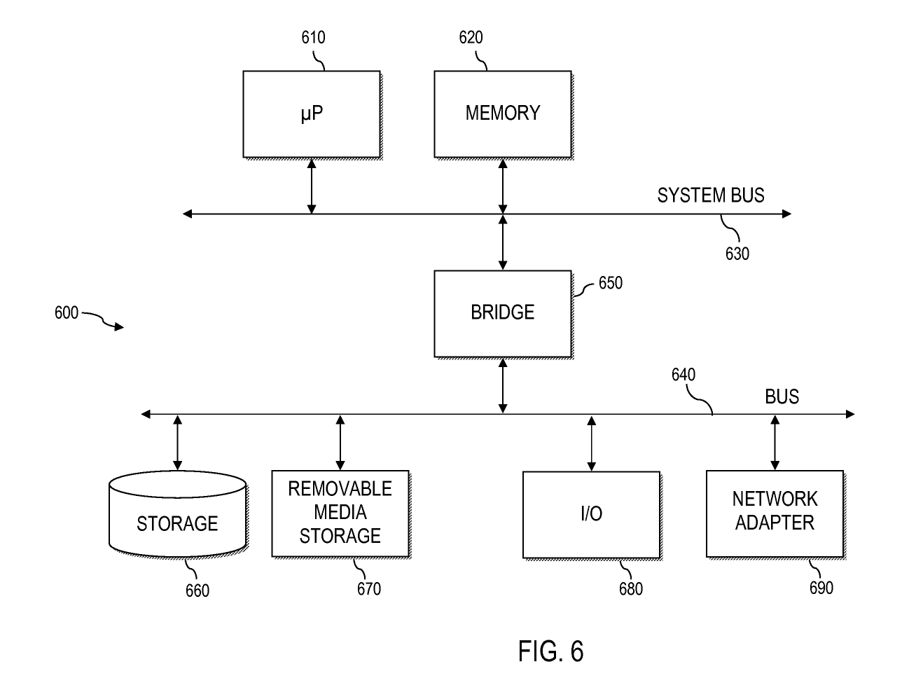

Referring to FIG. 3, an exemplary method 300 is illustrated for developing a dual-compression stage inlet for a scramjet engine, according to various aspects of the present invention. The method 300 comprises defining a first inlet model at 310, defining a second inlet model at 320, and blending at 330, the first inlet model and the second inlet model to derive a third inlet model, which models the desired dual-compression stage inlet. The method of FIG. 3 may be implemented, for instance, using the computer system of FIG. 6, described in greater detail below.

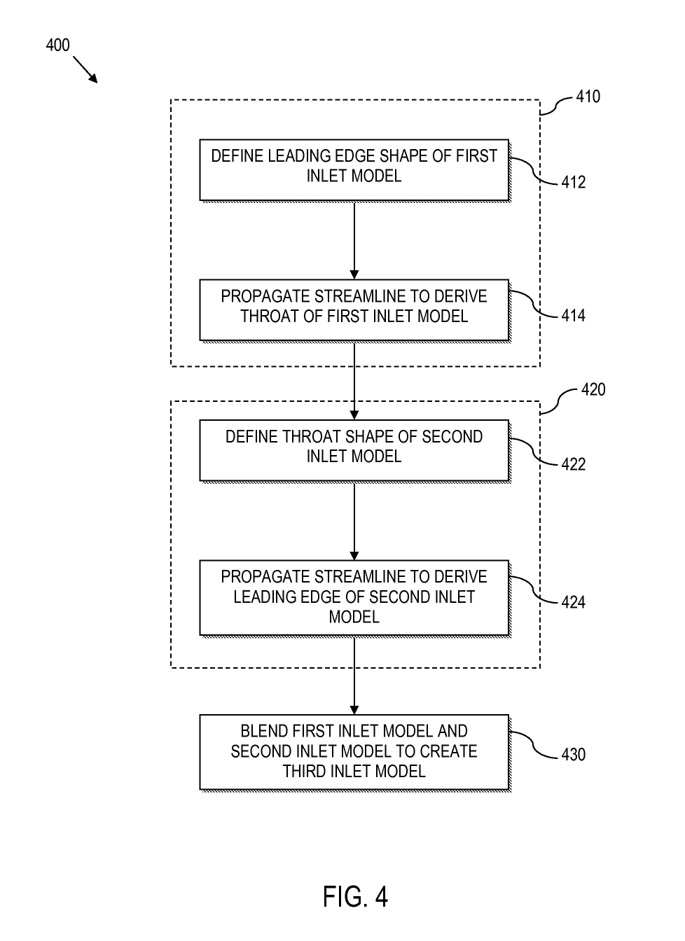

Referring to FIG. 4, an exemplary method 400 is illustrated for developing a dual-compression stage inlet for a scramjet engine, according to further aspects of the present invention. At 410, a user defines a first inlet model (similar to FIG. 3, 310). As an illustrative example, the first inlet model can be defined by defining a leading edge shape of the first inlet model at 412 and propagating the streamlines from the lip shape to derive a throat shape of the first inlet model at 414. More particularly, as noted above, an inlet includes a leading edge (222 FIG. 2) (i.e., a lip), a crotch (212 FIG. 2), and a throat (224 FIG. 2). Thus, at 412, the user defines a leading edge shape. Then, at 414, the user propagates streamlines starting at the leading edge, and the throat of the first inlet model results from the propagation of the streamlines. Therefore, the throat of the first model includes a cross-sectional shape similar to a cross-sectional shape of the defined leading edge. However, the cross-sectional shape of the throat is distorted when compared to the cross-sectional shape of the defined leading edge. This distortion is due to the annular nature of the desired flowfield. Thus, in the first inlet model, the user defines the desired leading edge shape and derives the throat shape.

At 420, the user defines a second inlet model (similar to FIG. 3, 320). As an illustrative example, the second inlet model can be defined by defining a throat shape of the second inlet model at 422 and propagating a streamline to derive a leading edge of the second inlet model at 424. More particularly, at 422, the user defines a desired throat shape. At 424, the user propagates streamlines starting at the throat to define a leading edge (e.g., the leading edge of the second inlet model results from the propagation of the streamline). Therefore, the leading edge of the second model includes a cross-sectional shape similar to a cross-sectional shape of the defined throat. However, the cross-sectional shape of the leading edge is distorted when compared to the cross-sectional shape of the defined throat. This distortion is due to the annular nature of the desired flowfield.

Thus, in the first inlet model, the user defines the desired leading edge and derives the throat shape, whereas in the second inlet model, the user defines the desired throat shape and derives the leading edge shape. In both the first inlet model and the second inlet model, the leading edge includes a cross-sectional shape similar to, but distorted when compared to a cross-sectional shape of the defined throat. However, since each inlet model is taken from a different perspective, the results are likely to be different.

At 430, the first inlet model is blended with the second inlet model to create a third inlet model (similar to FIG. 3, 330). To ensure proper blending, both inlets should have equivalent geometric quantities (i.e., projected frontal area and throat area, such as projected from the inlet lip). According to further aspects of the present invention, flowfields can have similar origin points (crotch locations) and be generated in the same general flowline coordinate system. The blending can be accomplished by utilizing various blending functions, for example, a simple blend might consist of a linear blend based on distance:

X(inlet 3)=X(inlet1)+(X(inlet2)−X(inlet1))*Bfunction

Y(inlet 3)=Y(inlet1)+(Y(inlet2)−Y(inlet1))*Bfunction

Z(inlet 3)=Z(inlet1)+(Z(inlet2)−Z(inlet1))*Bfunction

Where (inlet3) is the new inlet, (inlet1) is the leading-edge-shaped inlet, (inlet2) is the throat-shaped inlet, and Bfunction is a function of arc length or axial distance along each streamline, which varies from 0 to 1. X, Y, and Z represent directions in three-dimensional space. Other examples of blending techniques are: NURBS-based (non-uniform rational basis spline) techniques or Bezier-curve-based parametric streamlines. The user then uses this third inlet model as the dual-compression stage inlet for supersonic applications (e.g. for scramjet engines).

The flowfield models can be generated with self-similar streamlines from the annular compression fields. That is, defining a first inlet model (e.g., see 310 in FIGS. 3 and 410 in FIG. 4) can include defining a first self-similar inlet model, and defining a second inlet model (e.g., see 320 in FIGS. 3 and 420 in FIG. 4) can include defining a second self-similar inlet model. The self-similar nature of the streamlines provides a convenient approach for scaling the streamlines and generating the inlets with less computational effort. Moreover, self-similar streamlines can also be accomplished using parametric curve representations of the streamlines.

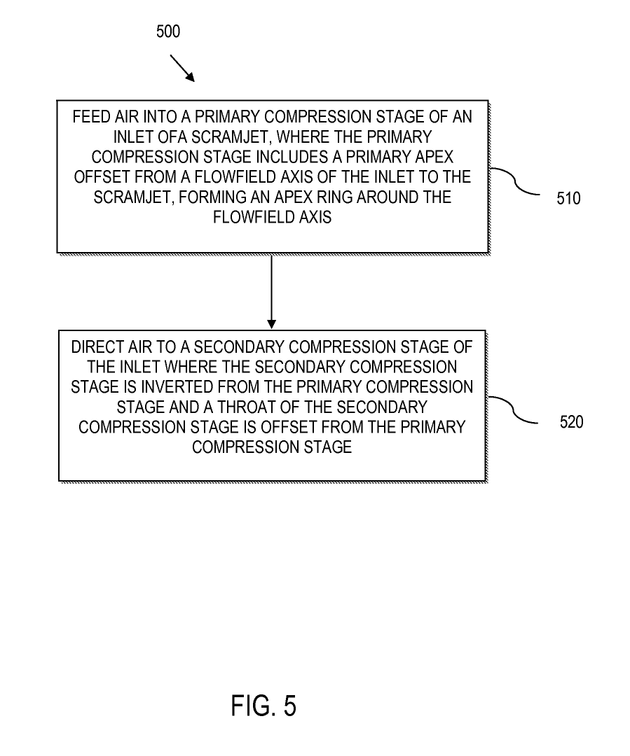

Referring to FIG. 5, a method 500 for reducing internal shockwave strength in a scramjet, the method comprises feeding air into a primary compression stage of an inlet of the scramjet at 510. In this implementation, the primary compression stage includes a primary apex, which is offset from a flowfield axis of the inlet to the scramjet, forming an apex ring around the flowfield axis. The method 500 further comprises directing the air to a secondary compression stage of the inlet of the scramjet at 520. The secondary compression stage is inverted from the primary compression stage and a throat of the secondary compression stage is offset from the primary compression stage. In illustrated implementations, the throat of the secondary compression stage is offset from the primary compression stage apex in the direction of the flowfield axis.

The dual-compression stage inlet described above produces low internal contraction ratios with high overall contraction ratio levels. As an example, the methods described above can be used to create an inlet with an overall contraction ratio of 7.0 with an internal contraction ratio between 1.25-1.5 while maintaining full capture of air at Mach 7. Thus, various aspects of the present invention combine high overall inlet contraction ratios (˜7.0) with low internal contraction ratios (˜1.3) while maintaining full capture or near full capture at a desired speed (˜M7).

As mentioned above, the Kantrowitz limit is traditionally used as an assessment of inlet starting capability. The Kantrowitz limit is a theoretical bound of internal contraction as a function of local Mach number where an inlet is likely to start. Inlets with internal contractions near or below the Kantrowitz limit, as described in greater detail herein, will reduce or completely eliminate the need for inlet starting devices.

Active starting devices (e.g., inlet dump doors) and passive starting devices (e.g., bleed holes) take up space within the inlet. However, according to aspects of the present invention, the inlet and methods herein enable the elimination or reduction in size of such devices, reduces the volume the scramjet engine requires for the inlet and frees up more volume in the engine for other subsystems, fuel, or both. Further, the resulting scramjet engine inlet as described more fully herein, is less complicated from a systems standpoint, because there are less or no starting devices in the engine.

Further, this exemplary inlet can provide full mass capture at cruise speeds. The internal contraction is below the Kantrowitz limits (i.e., the scramjet engine is self-starting). Moreover, the exemplary inlet has improved operability relative to Busemann-style inward-turning inlets and reduced separation along with good spillage characteristics at low supersonic Mach numbers. For example, below the design Mach number, the exemplary inlet captures more air than a planar inlet and can reach Busemann inlet levels depending on the annularity of the flowfield.

According to various aspects of the present invention, inward turning inlets are derived from axisymmetric flowfields. The inlets utilize multiple compression sections and an inverted secondary compression region, such that an internal compression section realizes low internal contraction for self-starting. Low internal contraction results from aligning the flow of air with the slope of the crotch by angling the internal surface of the crotch and offsetting the throat in the direction of the flowfield axis, which makes the secondary compression flowfield work efficiently. In certain implementations, the curves at the boundary plane between the two compression flowfields are parallel to each other such that the transition is smooth and continuous.

According to further aspects of the present invention, an axisymmetric flowfield comprises an annular flow. In this regard, as the inner radius of the annular flowfield approaches an outer radius, the flowfield approaches planar conditions. Accordingly, aspects set out more fully herein may be applied to planar inlets. Likewise, as an inner radius approaches the apex, the flow becomes fully axisymmetric. Accordingly, aspects set out more fully herein may be applied to Busemann-type inlets.

Moreover, the inward-turning inlets, according to illustrative implementations of the present invention, do not require any variable geometry. As used herein, axisymmetric and near-axisymmetric compression flowfields are also referred to as inward turning.

Referring to FIG. 6, a schematic block diagram illustrates an exemplary computer system 600 for implementing the various methods described herein, e.g., by interacting with a user. The exemplary computer system 600 includes one or more microprocessors (μP) 610 and corresponding memory 620 (e.g., random access memory and/or read only memory) that are connected to a system bus 630. Information can be passed between the system bus 630 and bus 640 by a suitable bridge 650. The bus 640 is used to interface peripherals with the one or more microprocessors (μP) 610, such as storage 660 (e.g., hard disk drives); removable media storage devices 670 (e.g., flash drives, DVD-ROM drives, CD-ROM drives, floppy drives, etc.); I/O devices 680 (e.g., mouse, keyboard, monitor, printer, scanner, etc.); and a network adapter 690. The above list of peripherals is presented by way of illustration, and is not intended to be limiting. Other peripheral devices may be suitably integrated into the computer system 600.

The microprocessor(s) 610 control operation of the exemplary computer system 600. Moreover, one or more of the microprocessor(s) 610 execute computer readable code that instructs the microprocessor(s) 610 to implement the methods herein. The computer readable code may be stored for instance, in the memory 620, storage 660, removable media storage device 670 or other suitable tangible storage medium accessible by the microprocessor(s) 610. The memory 620 can also function as a working memory, e.g., to store data, an operating system, etc.

Thus, the exemplary computer system 600 or components thereof can implement methods and computer-readable storage devices as set out in greater detail herein. Other computer configurations may also implement the methods and computer-readable storage devices as set out in greater detail herein. Computer program code for carrying out operations for aspects of the present invention may be written in any combination of one or more programming languages. The program code may execute entirely on the computer system 600, partly on the computer system 600, partly on the computer system 600 and partly on a remote computer or entirely on a remote computer or server. In the latter scenario, the remote computer may be connected to the computer system 600 through any type of network connection, e.g., using the network adapter 690 of the computer system 600.

Aspects of the present invention are described herein with reference to flowchart illustrations of methods and computer program products according to embodiments of the invention. Each block of the flowchart illustrations can be implemented by computer program instructions. These computer program instructions may be provided to a processor to produce a machine, such that the instructions, which execute via the processor of the computer or other programmable data processing apparatus, create means for implementing the functions/acts specified in the flowchart.

These computer program instructions may also be stored in a computer readable storage medium (i.e., computer readable storage device) such that the instructions stored in the computer readable medium produce an article of manufacture including instructions, which implement the function/act specified in the flowcharts when implemented by a processor.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. Aspects of the invention were chosen and described in order to best explain the principles of the invention and the practical application, and to enable others of ordinary skill in the art to understand the invention for various embodiments with various modifications as are suited to the particular use contemplated.

1. A method for developing a dual-compression stage inlet for supersonic applications, the method comprising:
defining a first inlet model;
defining a second inlet model; and
blending, with a processor, the first inlet model and the second inlet model to derive a third inlet model, which models the desired dual-compression stage inlet.

2. The method of claim 1, wherein defining the first inlet model includes:
defining a leading edge shape; and
propagating streamlines starting at the leading edge to define a throat shape.

3. The method of claim 1, wherein defining the second inlet model includes:
defining a throat shape; and
propagating streamlines starting at the throat to define a leading edge shape.

4. The method of claim 1, wherein:
defining a first inlet model includes defining a first self-similar inlet model; and
defining a second inlet model includes defining a second self-similar inlet model.

5. A method for reducing internal shockwave strength in a supersonic inlet, the method comprising:
feeding air into a primary compression stage of an inlet, wherein the primary compression stage includes a primary apex, which is offset from a flowfield axis of the inlet, forming an apex ring around the flowfield axis; and
directing the air to a secondary compression stage of the inlet, wherein the secondary compression stage is inverted from the primary compression stage and a throat of the secondary compression stage is offset from the primary compression stage.

6. The method of claim 5, wherein the throat of the secondary compression stage is offset from the primary compression stage apex in the direction of the flowfield axis.

7. An inlet for supersonic applications, the inlet comprising:
a primary compression stage including:
a crotch, and
a curve, and
a secondary compression stage including:
a curve that is inverted from the curve of the primary compression stage, and
a throat that is offset from the primary compression stage.

8. The inlet of claim 7, wherein the curves at a boundary plane between a primary compression flowfield and a secondary compression flowfield are parallel to each other, providing a smooth and continuous transition.

9. The inlet of claim 7, wherein the supersonic application comprises a supersonic engine inlet and the secondary compression stage includes a maximum internal compression ratio equal to a Kantrowitz limit to allow supersonic engine inlet to self-start.

10. The inlet of claim 7, wherein the throat of the secondary compression stage feeds a select one of an isolator or combustor of the supersonic engine.

11. The inlet of claim 6, wherein the secondary compression stage is sufficiently offset from the primary compression stage to weaken the strength of shockwaves that propagate in the inlet.

12. The inlet of claim 7, wherein the crotch couples with the secondary compression stage such that an internal surface at the crotch aligns with a flow of air from the crotch to the second compression stage.

13. The inlet of claim 7, wherein the throat is offset from the primary compression stage in the direction of the flowfield axis.

14. The inlet of claim 7, wherein the inlet is free of variable geometry.

15. The inlet of claim 7, wherein the inlet is derived from an axisymmetric flowfield.

16. The inlet of claim 15, wherein the axisymmetric flowfield is an annular flow.

17. The inlet of claim 7 wherein the primary apex is offset from a flowfield axis of the inlet, forming an apex ring around the flowfield axis.

18. The inlet of claim 5, wherein a low internal contraction at or below the Kantrowitz limit is due to the design of the secondary compression flowfield.
